(19) United States
(12) Patent Application Publication
(10) Pub. No.: US 2014/0152150 A1
(43) Pub. Date: Jun. 5, 2014

(54) PIEZOELECTRIC MOTOR, LIQUID EJECTING APPARATUS AND TIMEPIECE

(71) Applicant: Seiko Epson Corporation, Tokyo (JP)

(72) Inventors: Akihito Matsumoto, Chino-shi (JP); Osamu Miyazawa, Nagano-ken (JP); Yasuharu Hashimoto, Nagano-ken (JP); Akira Matsuzawa, Shiojiri-shi (JP)

(73) Assignee: Seiko Epson Corporation, Tokyo (JP)

(21) Appl. No.: 14/175,735

(22) Filed: Feb. 7, 2014

Related U.S. Application Data
(63) Continuation of application No. 12/732,051, filed on Mar. 25, 2010.

(51) Int. Cl. H02N 2/12

(52) U.S. Cl. CPC H02N 2/12
USPC 310/323.16

(57) ABSTRACT

A piezoelectric motor includes: a piezoelectric actuator; and a driven portion. The piezoelectric actuator includes a piezoelectric element and a vibration member. The piezoelectric element has a piezoelectric layer and a first and a second electrode provided on both surfaces of the piezoelectric layer, respectively, and the vibration member is fixed on the first electrode side of the piezoelectric element. The driven portion which is rotated by the protrusion portion of the vibration member vibrated by the piezoelectric element, while the driven portion being abutted thereon. In the piezoelectric motor, a plurality of grooves which are open at a tip end surface of the protrusion portion and penetrate in a thickness direction are provided on a plurality of points of the protrusion portion along a rotation direction of a rotation shaft of the driven portion.

### CROSS-REFERENCE TO RELATED APPLICATIONS

This application is a continuation of U.S. application Ser. No. 12/732,051 filed on Mar. 25, 2010, which claims the benefit of priority to Japanese Patent Application No. 2009-077874 filed Mar. 26, 2009, the contents of which are hereby incorporated by reference in their entireties.

### BACKGROUND

1. Technical Field

The present invention relates to a piezoelectric motor that drives a driven portion by a piezoelectric element, to a liquid ejecting apparatus that uses the piezoelectric motor, and to a timepiece that uses the piezoelectric motor.

2. Related Art

A piezoelectric motor rotationally drives a rotation shaft by a piezoelectric actuator including a piezoelectric element. The piezoelectric actuator for use in the piezoelectric motor includes: a vibration member; and the piezoelectric element held on one surface side of the vibration member. The piezoelectric element includes: a first electrode provided on a vibration member side; a piezoelectric layer; and a second electrode provided on the piezoelectric layer on the opposite side of the first electrode, while the vibration member and the first electrode are adhered to each other by interposing an adhesive therebetween.

In the piezoelectric actuator as described above, a voltage is applied between the first and second electrodes of the piezoelectric element, and the piezoelectric element is longitudinally and flexurally vibrated in an in-plane direction of the vibration member, whereby the vibration member is vibrated. Note that a protrusion portion is provided on one side of the vibration member so as to be protruded forward in the in-plane direction, and a tip end of the protrusion portion elliptically moves according to vibrations of the vibration member, which follow the longitudinal and flexural vibrations of the piezoelectric element. The tip end of the protrusion portion abuts on a side surface of the rotation shaft as a driven portion, whereby the rotation shaft is rotationally driven by frictional force that follows the elliptical motion of the protrusion portion. JP-A-2007-267482 is an example of the related art.

As described above, the piezoelectric actuator drives the driven portion through the protrusion portion by the frictional force. Therefore, friction and abrasion of the protrusion portion occur on such a tip end portion of the piezoelectric actuator, which abuts on the driven portion. Such deformation of the protrusion portion caused by the friction and abrasion defines a lifetime of the piezoelectric actuator. Hence, it is important to enhance durability of the protrusion portion of the vibration member in order to ensure stable performance of the piezoelectric actuator for a long period.

### SUMMARY

An advantage of some aspects of the invention is to provide a piezoelectric motor capable of enhancing abrasion resistance of a protruding portion in the piezoelectric actuator, and a liquid ejecting apparatus and a timepiece, each of which uses the piezoelectric motor.

In accordance with an aspect of the invention, a piezoelectric motor includes: a piezoelectric actuator including a piezoelectric element and a vibration member, the piezoelectric element having a piezoelectric layer and a first and a second electrodes provided on both surfaces of the piezoelectric layer, respectively, and the vibration member being fixed on the first electrode side of the piezoelectric element; and a driven portion rotated in such a manner that a protrusion portion of the vibration member vibrated by the piezoelectric element abuts and rotates the driven portion. The protrusion portion has a plurality of grooves along the rotation direction of the rotation shaft of the driven portion; each groove opens toward the rotation shaft of the driven portion and penetrates in the thickness direction of the protrusion portion.

In accordance with the aspect of the invention, a tip end of the protrusion portion is abraded owing to initial friction between the protrusion portion and the driven portion. Wear debris generated by the abrasion at this time may enter the grooves. As a result, when contact of the protrusion portion with the driven portion is continued in a state where the grooves are fully filled with the wear debris, the tip end surface of the protrusion portion turns to be in an extremely smoothly-polished state. Therefore, abrasion resistance of the protrusion portion is enhancively improved.

It is preferable that the grooves be formed so as to be deeper downstream with respect to the rotation direction of the rotation shaft. This is because the grooves are filled with the wear debris in order from the groove that is upstream in the rotation direction, whereby such a smooth surface is expanded satisfactorily along the rotation direction. Moreover, it is preferable that the grooves be formed so as to be deeper from a center point toward both side ends of the protrusion portion in a width direction of the protrusion portion. In this case, the smooth surface may be expanded satisfactorily even if the driven portion is rotated in both directions. Furthermore, a plurality of grooves which are open at a contact surface of the driven portion with the protrusion portion and penetrate in the thickness direction may be provided on the driven portion along the rotation direction of the driven portion. In this case, functions and effects similar to those mentioned above may also be achieved on the driven portion side.

In accordance with another aspect of the invention, a liquid ejecting apparatus is provide, including the piezoelectric motor according to the above-described aspect. In accordance with such an aspect, a liquid ejecting apparatus may be realized, whose size is reduced and durability is enhanced. In particular, the piezoelectric motor suitably serves as a transporting unit that transports an ejection target medium onto which a liquid is to be ejected.

In accordance with still another aspect of the invention, a timepiece is provided, including the piezoelectric motor according to the above-described aspect. In accordance with such an aspect, a timepiece may be realized, whose size is reduced and durability is enhanced.

### BRIEF DESCRIPTION OF THE DRAWINGS

The invention will be described with reference to the accompanying drawings, wherein like numbers reference like elements.

FIG. 1 is an exploded perspective view of a piezoelectric motor according to a first embodiment.

FIG. 2 is a plan view of the piezoelectric motor according to the first embodiment.

FIG. 3 is a sectional view of the piezoelectric motor according to the first embodiment.

FIGS. 4A to 4C are plan views illustrating operations of a piezoelectric actuator according to the first embodiment.

FIG. 5 is a plan view illustrating the operations of the piezoelectric actuator according to the first embodiment.

FIGS. 6A, 6C, and 6D are enlarged views illustrating an extracted protrusion portion in the first embodiment, and FIG. 6B is an enlarged top view of the protrusion portion extracted.

FIG. 7 is a schematic perspective view of a recording apparatus according to an embodiment.

FIG. 8 is an enlarged plan view of a main portion of the recording apparatus according to the embodiment.

FIG. 9 is a plan view of a timepiece according to another embodiment.

### DESCRIPTION OF EXEMPLARY EMBODIMENTS

A description will be made below in detail of the invention on the basis of embodiments.

### First Embodiment

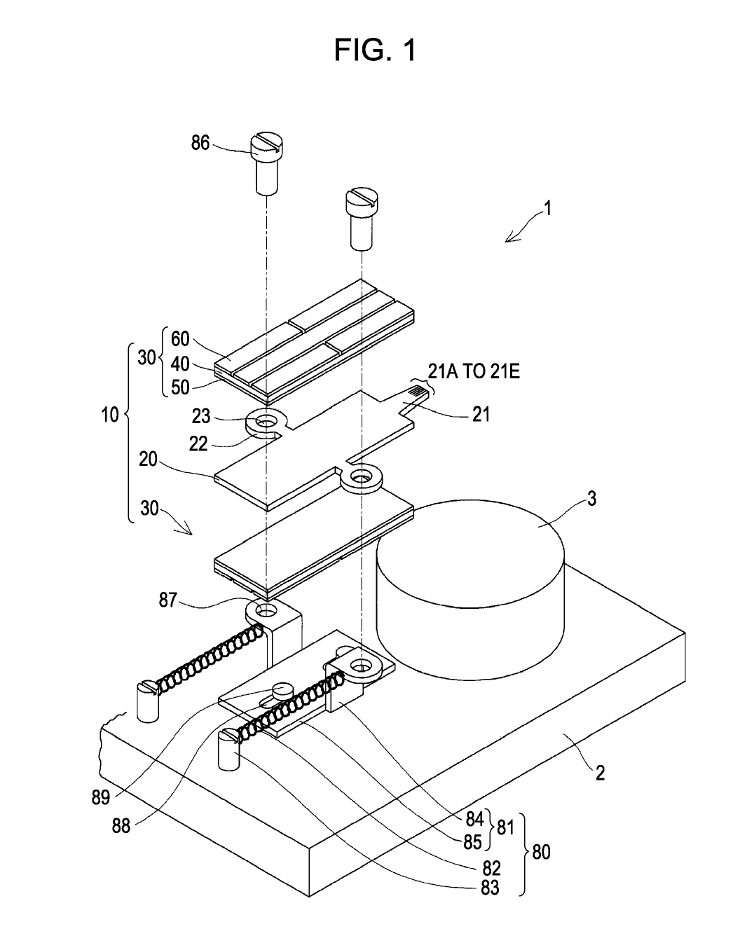

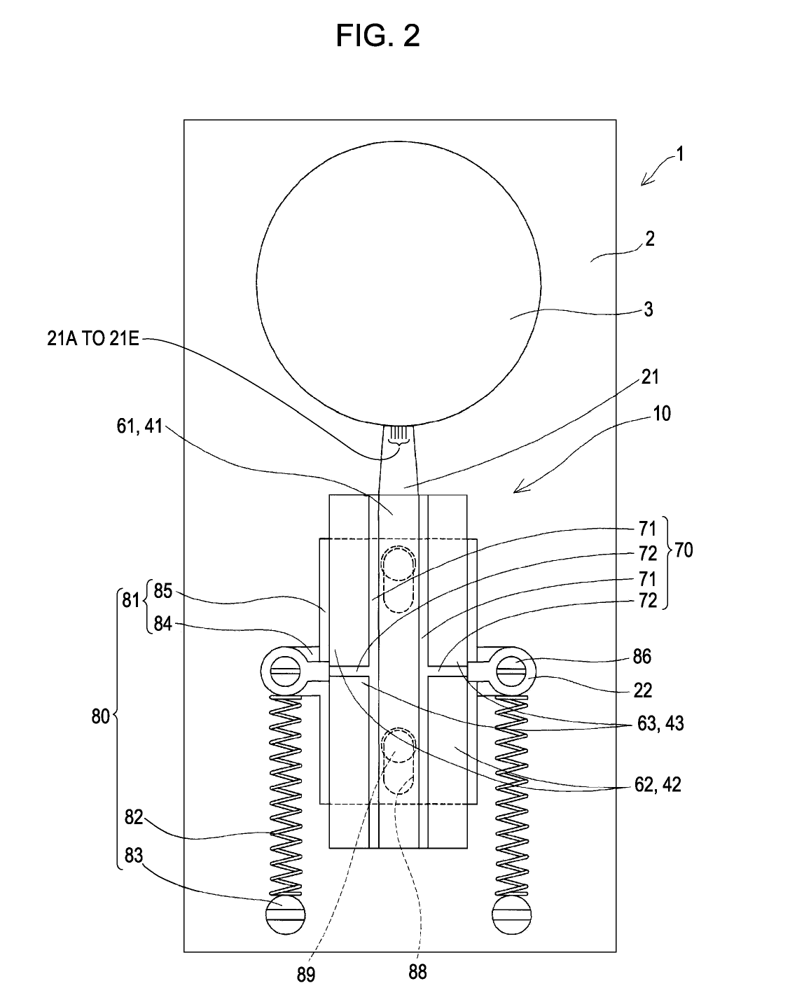

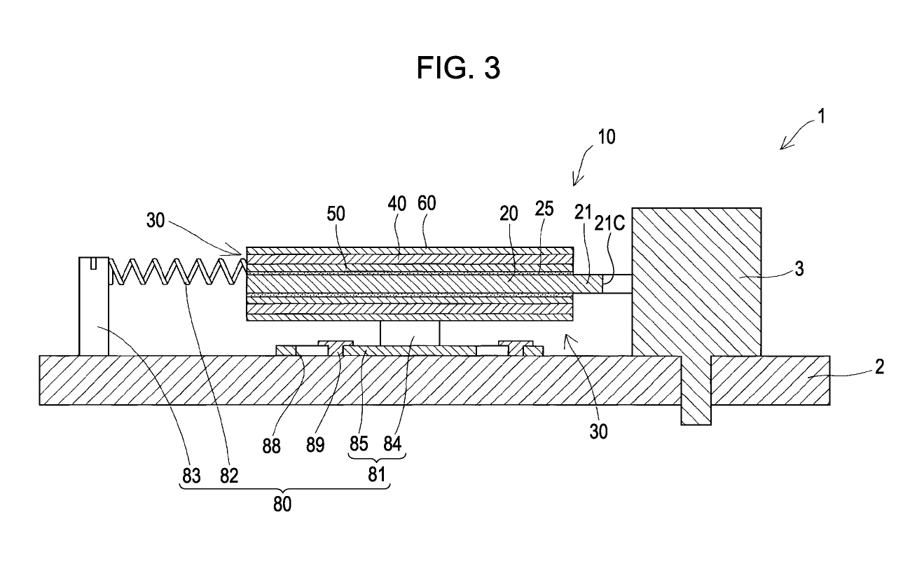

FIG. 1 is an exploded perspective view of a piezoelectric motor according to a first embodiment of the invention, FIG. 2 is a plan view of the piezoelectric motor, and FIG. 3 is a sectional view of the piezoelectric motor.

As shown in these drawings, a piezoelectric actuator 10 that configures the piezoelectric motor 1 of this embodiment includes: a vibration member 20; and piezoelectric elements 30 adhered to both surfaces of the vibration member 20.

Each of the piezoelectric elements 30 provided on both surfaces of the vibration member 20 includes: a piezoelectric layer 40; a first electrode 50 provided on the vibration member 20 side of the piezoelectric layer 40; and a second electrode 60 provided on a side of the piezoelectric layer 40, which is opposite to the first electrode 50.

The piezoelectric layer 40 is made of a piezoelectric material that gives an electromechanical conversion function, and in particular, made of a metal oxide having a perovskite structure represented by a general formula ABO₃ among such piezoelectric materials. As the piezoelectric layer 40, for example, suitable are: a ferroelectric material such as lead zirconate titanate (PZT); a material in which the PZT is added with a metal oxide such as niobium oxide, nickel oxide and magnesium oxide; and the like. To be more specific, there may be used lead titanate (PbTiO₃), lead zirconate titanate (Pb(Zr,Ti)O₃), lead zirconate (PbZrO₃), lead lanthanum titanate ((Pb,La),TiO₃), lead lanthanum zirconate titanate ((Pb,La)(Zr,Ti)O₃), lead magnesium niobate zirconium titanate (Pb(Zr,Ti)(Mg,Nb)O₃), or the like. As a matter of course, the piezoelectric layer 40 of this embodiment is not limited to the above-described materials; however, those containing lead are mentioned as the piezoelectric layer 40 having an excellent electromechanical conversion function.

The first electrode 50 is a common electrode provided continuously over the vibration member 20 side surface of the piezoelectric layer 40.

In each of the piezoelectric elements 30, a center portion thereof in a longitudinal direction serves as a base point in longitudinal vibrations and flexural vibrations, and a displacement of the center portion in the longitudinal direction is relatively small. This will be described later in detail.

The second electrode 60 is provided on the side of the piezoelectric layer 40, which is opposite to the first electrode 50. By a groove portion 70, the second electrode 60 is electrically isolated from one another and divided into a plurality of pieces in an in-plane direction.

The groove portion 70 that divides the second electrode 60 includes: first groove portions 71 formed so as to substantially trisect a width (lateral direction) of the piezoelectric element 30; and second groove portions 72 formed so as to substantially bisect, in the longitudinal direction, electrodes on both sides in the lateral direction among three electrodes divided by the first groove portions 71. By the groove portion 70 including these first groove portions 71 and second groove portions 72, the second electrode 60 is divided into five portions in total, which are: a longitudinally vibrating electrode portion 61 provided along the longitudinal direction on a center portion thereof in the lateral direction; and two pairs of flexurally vibrating electrode portions 62 and 63, each pair of which is arranged on both sides of the longitudinally vibrating electrode portion 61 in the lateral direction so as to be diagonally opposite to each other while sandwiching the longitudinally vibrating electrode portion 61 therebetween. Note that, in the piezoelectric element 30, a region thereof where the longitudinally vibrating electrode member 61 of the second electrode 60 is provided becomes a longitudinal vibration excitation region 41 that excites the longitudinal vibrations of the piezoelectric element 30 in the longitudinal direction. As opposed to this, regions of the piezoelectric element 30 on both sides of the longitudinal vibration excitation region 41 in the lateral direction, where the flexurally vibrating electrode portions 62 and 63 are provided, individually become flexural vibration excitation regions 42 and 43 which excite the flexural vibrations in the lateral direction of the piezoelectric element 30.

The first electrode 50 side of the piezoelectric elements 30 as described above is adhered to the vibration member 20 by interposing an adhesive 25 therebetween. Note that the vibration member 20 is configured with a plate-like member formed of a metal such as stainless steel (SUS) or of a resin material. In this embodiment, the vibration member 20 is formed of the stainless steel having conductivity, and is allowed to also function as a common electrode that conducts electricity between the first electrodes 50 of the two piezoelectric elements 30.

As described above, the vibration member 20 has the same surface shape as that of the first electrode 50 side of each piezoelectric element 30. On one end portion side of the vibration member 20 in the longitudinal direction, a protrusion portion 21 extended so as to protrude from the piezoelectric elements 30 is provided. On a center portion of the vibration member 20 in the longitudinal direction of the piezoelectric elements 30, a pair of arm portions 22 are provided, which are extended toward both sides of the piezoelectric elements 30 in the lateral direction. In these arm portions 22, through-holes 23 which penetrate the arm portions 22 in a thickness direction thereof are provided. The arm portions 22 are fixed to a holding member 81, which is to be described later in detail, with screw members 86 inserted through the through- holes 23. In other words, in the piezoelectric actuator 10, the arm portions 22 of the vibration member 20 are fixed to the holding member 81, whereby the piezoelectric elements 30 are held on the holding member 81 so as to be capable of vibrating longitudinally and flexurally with respect to the holding member 81 from the arm portions 22 taken as base points.

The first electrode 50 side of each piezoelectric element 30 is adhered to the vibration member 20 as described above while interposing the adhesive 25 therebetween. To be more specific, the adhesive 25 that adheres the vibration member 20 and each piezoelectric element 30 to each other is applied between the vibration member 20 and each piezoelectric element 30.

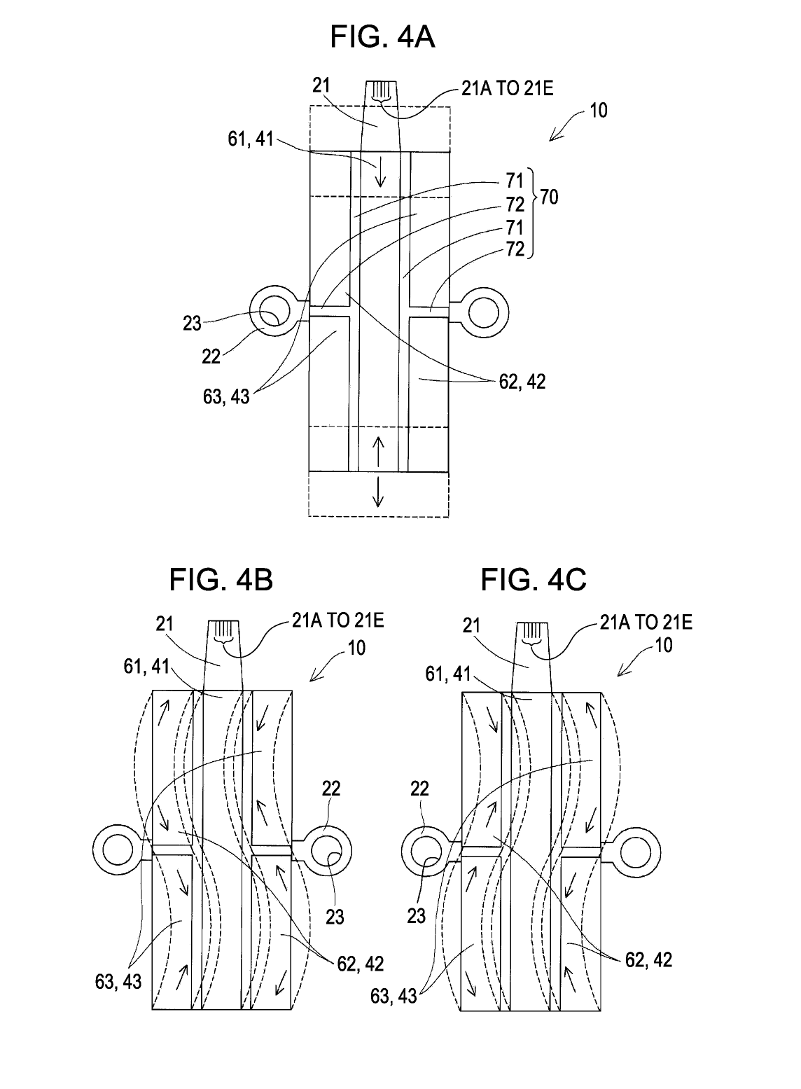

In the piezoelectric actuator 10 as described above, the longitudinal vibration excitation region 41 and flexural vibration excitation regions 42 and 43 of the piezoelectric element 30 are driven to individually vibrate longitudinally and flexurally in a plane direction. In other words, as shown in FIG. 4A, in the plane direction of the vibration member 20, the longitudinal vibration excitation region 41 is extended/contracted in the longitudinal direction, whereby the piezoelectric element 30 is allowed to longitudinally vibrate in the longitudinal direction.

Moreover, as shown in FIGS. 4B and 4C, in the plane direction of the vibration member 20, the flexural vibration excitation regions 42 and 43 are extended/contracted, whereby the piezoelectric element 30 is flexurally driven. To be more specific, the pair of flexural vibration excitation regions 42 diagonally opposite to each other in the lateral direction of the piezoelectric element 30, which is one of the pairs, are extended, and at the same time, the pair of flexural vibration excitation regions 43 diagonally opposite to each other in the lateral direction, which is the other of the pairs, are contracted. Accordingly, the piezoelectric element 30 is deformed in an S-shape as shown in FIG. 4B. On the other hand, the flexural vibration excitation regions 42 which have been extended are contracted, and at the same time, the flexural vibration excitation regions 43 which have been contracted are extended, whereby the piezoelectric element 30 is bent in an inverse S-shape as shown in FIG. 4C. Such deformation and flexure, which are shown in FIGS. 4B and 4C, are alternately repeated, whereby flexural vibrations in the S-shape and the inverse S-shape are given to the piezoelectric element 30.

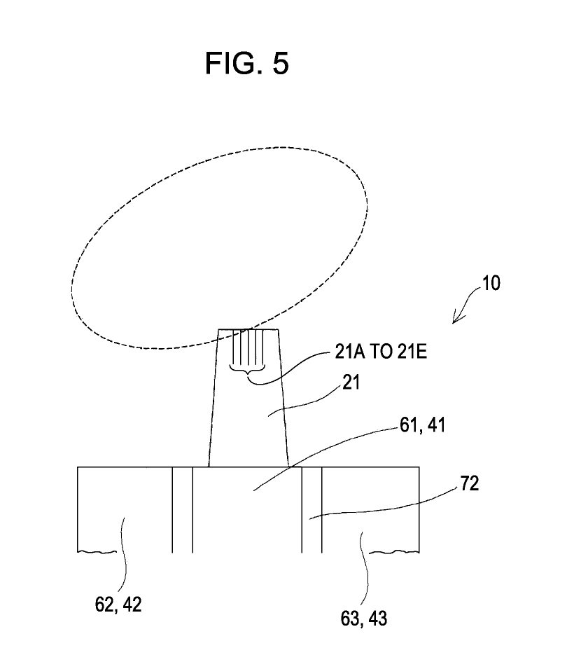

The piezoelectric element 30 is allowed to alternately repeat the longitudinal vibrations given by the longitudinal vibration excitation region 41 and the flexural vibrations given by the flexural vibration excitation regions 42 and 43. Accordingly, as shown in FIG. 5, an end portion of the piezoelectric element 30 in the longitudinal direction, that is, the protrusion portion 21 of the vibration member 20 may be rotationally driven so as to draw an elliptical orbit. To be more specific, the piezoelectric element 30 is allowed to sequentially and repeatedly perform the deformations, which are the extension in the longitudinal direction, the flexure in the S-shape, the contraction in the longitudinal direction, and the flexure in the inverse S-shape. Accordingly, the protrusion portion 21 may be rotationally driven so as to draw the elliptical orbit clockwise in the plane of the vibration member 20. In the event of deforming the piezoelectric element 30, the protrusion portion 21 may be rotationally driven so as to draw the elliptical orbit counterclockwise in the plane of the vibration member 20 in such a manner that the order of the flexures are interchanged. Note that, while the piezoelectric elements 30 are individually provided on both surfaces of the vibration member 20 in this embodiment, the two piezoelectric elements 30 perform the same longitudinal vibrations and flexural vibrations in the plane of the vibration member 20. In other words, the respective longitudinal vibration excitation regions 41 and flexural vibration excitation regions 42 and 43 of the two piezoelectric elements 30 are arranged so as to overlap with each other when the piezoelectric actuator 10 is viewed from top, that is, from the second electrode 60 side of one of the piezoelectric elements 30. The longitudinal vibration excitation regions 41 and the flexural vibration excitation regions 42 and 43 are allowed to perform the same extension/contraction in the regions which overlap with each other when viewed from top. Accordingly, the vibration member 20 is deformed in the in-plane direction. As a matter of course, it is also possible to deform and drive the vibration member 20 and the piezoelectric elements 30 in a stack direction thereof in such a manner that the piezoelectric elements 30 on both surfaces of the vibration member 20 are deformed in a different way.

As shown in FIGS. 1 and 2, a rotation shaft 3 freely rotatable about an axis thereof is provided on a device body 2 of the piezoelectric motor 1. The protrusion portion 21 of the piezoelectric actuator 10, which is rotationally driven so as to draw the elliptical orbit, is allowed to abut on the rotation shaft 3, whereby the rotation shaft 3 is rotated. Note that, on a tip end of the protrusion portion 21, a plurality of grooves 21A to 21E are formed in a direction along a rotation direction of the rotation shaft 3. The grooves 21A to 21E will be described later in detail. The protrusion portion 21 is made of an SUS plate, and is allowed to abut on the rotation shaft 3 made of metal.

Note that, in the piezoelectric motor 1, an urging unit 80 is provided, which urges the piezoelectric actuator 10 toward a direction of the rotation shaft 3 by predetermined pressure.

The urging unit 80 includes: a holding member 81 that holds the piezoelectric actuator 10; spring members 82 such as coil springs, in which both ends are fixed to the holding member 81; and eccentric pins 83 which abut on the other ends of the spring members 82, are fixed to the device body 2, and adjust urging force of the spring members 82.

The holding member 81 includes: a pair of fixing portions 84 to which the arm portions 22 of the piezoelectric actuator 10 are fixed; and a slide portion 85 that is provided between the fixing portions 84 integrally therewith, and is supported so as to be slidably movable with respect to the device body 2. In the fixing portions 84, female screw portions 87 to which the screw members 86 are screwed are formed so as to correspond to the through- holes 23 of the arm portions 22. The screw members 86 inserted into the through-holes 23 of the arm portions 22 are screwed to the female screw portions 87, whereby the piezoelectric actuator 10 is held on the holding member 81.

In the slide portion 85, two slide holes 88 are provided, which are long holes penetrating the slide portion 85 in a thickness direction thereof and extended in a sliding direction thereof. The slide portion 85 is supported on the device body 2 so as to be slidably movable with respect thereto by slide pins 89 inserted into the respective slide holes 88 and fixed to the device body 2.

The spring members 82 are formed of the coil springs, and are arranged so that the one ends thereof may be fixed to the fixing portions 84, and that the other ends thereof may abut on side surfaces of the eccentric pins 83 fixed to the device body 2 so as to be eccentrically rotatable. The spring members 82 are arranged along the sliding direction of the slide portion 85. The spring members 82 as described above urge the piezoelectric actuator 10 toward the rotation shaft 3 with respect to the device body 2. The eccentric pins 83 are provided so as to be eccentrically rotatable with respect to the device body 2. The eccentric pins 83 are eccentrically rotated, whereby an interval between the holding member 81 and the side surfaces of the eccentric pins 83 is changed, thus making it possible to adjust the urging force by the spring members 82.

Note that, though the coil springs are used as the spring members 82 in this embodiment, the spring members 82 are not limited to these, and for example, plate springs and the like may be used.

By the urging unit 80, the piezoelectric actuator 10 is urged to the rotation shaft 3 by the predetermined pressure so that the longitudinal direction (longitudinal vibration direction) of the piezoelectric elements 30 may coincide with an axis center of the rotation shaft 3. In other words, the piezoelectric actuator 10 of this embodiment is arranged so that the longitudinal direction of the piezoelectric elements 30 may coincide with a radial direction of the rotation shaft 3, and the piezoelectric actuator 10 is provided so as to be slidably movable toward the radial direction of the rotation shaft 3. Hence, the piezoelectric actuator 10 is urged so that the longitudinal direction of the piezoelectric elements 30 may coincide with the radial direction of the rotation shaft 3.

As described above, while urging the protrusion portion 21 of the piezoelectric actuator 10 to the rotation shaft 3 by the urging unit 80, the piezoelectric elements 30 are allowed to alternately perform the longitudinal vibrations and the flexural vibrations, and the protrusion portion 21 is thereby driven so as to draw the elliptical orbit. Accordingly, the rotation shaft 3 may be rotated.

Note that the number of revolutions of the rotation shaft 3 rotated by the piezoelectric actuator 10 is largely affected by a vibration cycle in which the longitudinal vibrations and the flexural vibrations are given. Moreover, torque of the rotation shaft 3 is largely affected by the urging force of the piezoelectric actuator 10 to the rotation shaft 3 by the urging unit 80.

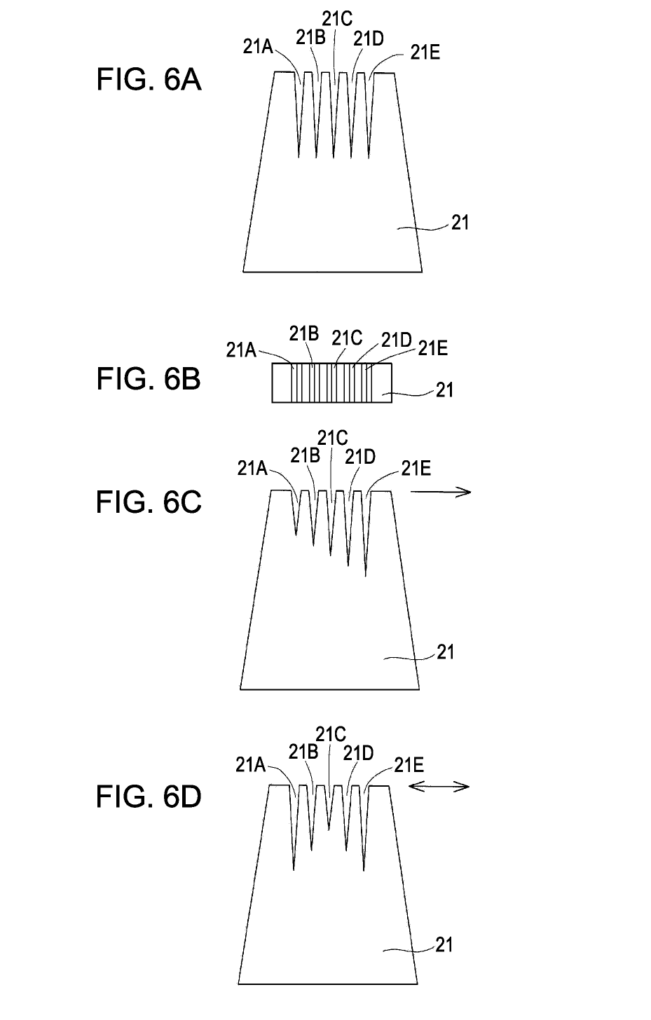

FIGS. 6A, 6C, and 6D are enlarged views illustrating the extracted protrusion portion in the first embodiment, and FIG. 6B is a top view of the protrusion portion. As shown in FIGS. 6A and 6B, on the protrusion portion 21 in this embodiment, the plurality (five in the drawings) of grooves 21A, 21B, 21C, 21D and 21E are provided along the rotation direction of the rotation shaft 3 (refer to FIGS. 1 and 2, the same will apply hereinafter). Such grooves 21A to 21E are open at a tip end surface of the protrusion portion 21, penetrate the protrusion portion 21 in the thickness direction, and have a triangular shape in which a width is gradually reduced toward a bottom portion.

The protrusion portion 21 having such grooves 21A to 21E is allowed to abut on the rotation shaft 3 as a driven portion, and performs the elliptical motion. Accordingly, in the case where the rotation shaft 3 is rotationally driven, the tip end of the protrusion portion 21 is abraded owing to initial friction between the protrusion portion 21 and the rotation shaft 3. At this time, in this embodiment, wear debris generated by the abrasion of the tip end enters the grooves 21A to 21E. In a state where the grooves 21A to 21E are fully filled with the wear debris, contact of the protrusion portion 21 with the rotation shaft 3 is continued, whereby a contact surface of the protrusion portion 21 with the rotation shaft 3 turns to be in an extremely smoothly-polished state (glazed state). Therefore, abrasion resistance of the protrusion portion 21 is enhanced. As described above, in this embodiment, the grooves 21A to 21E are filled with the wear debris generated by the friction between the protrusion portion 21 and the driven portion, whereby the contact surface on the tip end of the protrusion portion is converted into a smooth surface. Accordingly, the abrasion resistance of the tip end of the protrusion portion 21 is enhancively improved.

All of the grooves 21A to 21E shown in FIG. 6A are set to have the same depth; however, as shown in FIG. 6C or FIG. 6D, depths of the respective grooves 21A to 21E may be different from one another. Depths of the grooves 21A to 21E shown in FIG. 6C are gradually deepened sequentially from the groove 21A toward the groove 21E. A direction where the depths are gradually deepened is allowed to coincide with the rotation direction (arrow direction in FIG. 6C) of the rotation shaft 3. As a result, the wear debris generated by the contact of the protrusion portion 21 with the rotation shaft 3 enters the grooves 21A to 21E in order from the groove 21A that is upstream in terms of the rotation direction. Hence, the smooth surface on the contact surface of the protrusion portion 21 with the rotation shaft 3 is gradually expanded, the protrusion portion 21 having the upstream groove 21A to the downstream groove 21E filled with the contact debris in this order. Accordingly, the smooth surface is grown and formed continuously and satisfactorily.

The rotation direction of the rotation shaft 3 that rotates through the protrusion portion 21 is not limited to one direction, but may be both directions in some cases. In this case, as shown in FIG. 6D, the depths of the grooves 21B and 21D and the grooves 21A and 21E just need to be gradually deepened as going from the center groove 21C to right and left end portions in the rotation directions (both directions indicated by an arrow in the drawing). In this case, in both of the clockwise and counterclockwise directions, the smooth surface may be satisfactorily formed on the tip end surface of the protrusion portion 21.

As described above, in the piezoelectric actuator 10 for use in the piezoelectric motor 1 of this embodiment, the grooves 21A to 21E are provided on the protrusion portion 21, whereby the contact surface of the protrusion portion 21 with the rotation shaft 3 may be formed into the smooth surface excellent in abrasion resistance.

### Other Embodiments

The description has been made above according to an aspect of the invention; however, a basic configuration is not limited to the above-mentioned one. For example, in the above-mentioned first embodiment, the piezoelectric actuator 10 is illustrated, in which the piezoelectric elements 30 are individually provided on both surfaces of the vibration member 20. However, the piezoelectric actuator of the invention is not particularly limited to this. The invention is also applicable to a piezoelectric actuator 10 in which the piezoelectric element 30 is provided only on one side of the vibration member 20.

Moreover, in the above-mentioned first embodiment, the piezoelectric actuator 10 is urged toward the rotation shaft 3 by the urging unit 80; however, an urging target by the urging unit 80 is not particularly limited to this. For example, the urging unit 80 may urge the rotation shaft 3 toward the piezoelectric actuator 10.

Furthermore, it is not necessary to limit the material of the protrusion portion 21 to SUS (metal). For example, the material of the protrusion portion 21 may be aluminum oxide or ceramics such as zirconia.

In the above-mentioned embodiment, the grooves 21A to 21E are provided only on the protrusion portion 21; however, similar grooves may also be provided on the driven portion (rotation shaft 3) side. In this case, similar effects may be expected also on the driven portion side.

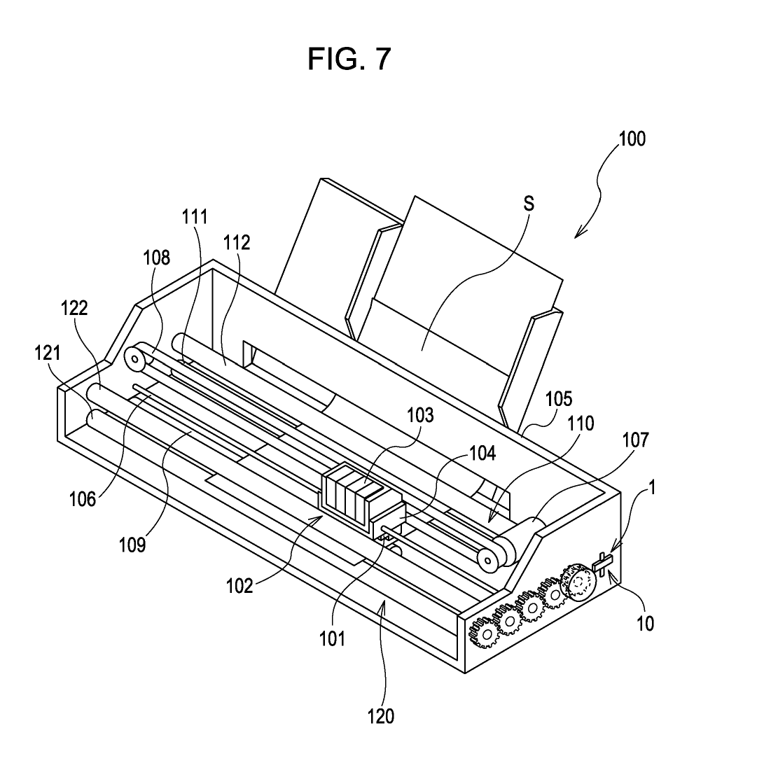

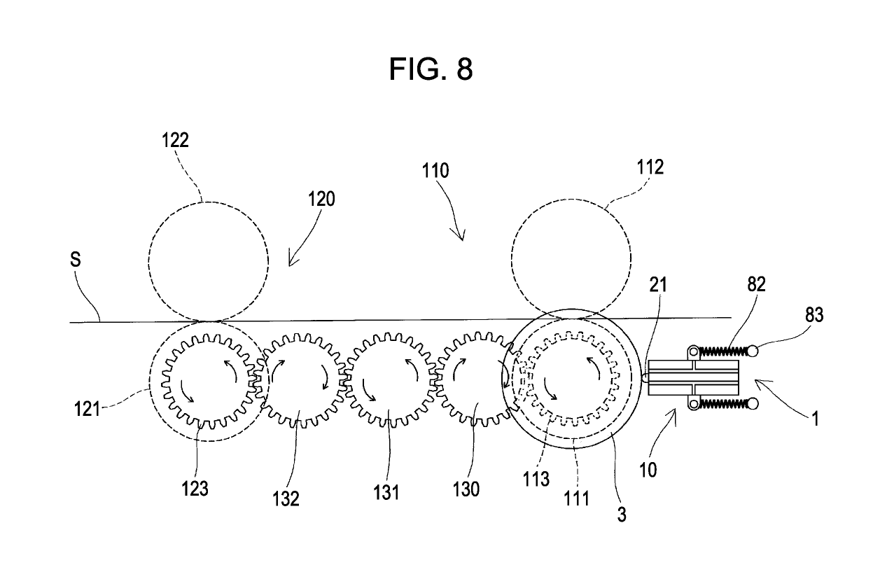

The piezoelectric motor 1 of the above-mentioned embodiment may be used as a drive unit of an ink jet recording apparatus as an example of a liquid ejecting apparatus. FIGS. 7 and 8 illustrate an example of the ink jet recording apparatus using the piezoelectric motor 1 of the first embodiment. FIG. 7 is a schematic perspective view of the ink jet recording apparatus as an example of a liquid ejecting apparatus according to an embodiment, and FIG. 8 is an enlarged plan view of a main portion of the ink jet recording apparatus.

In the ink jet recording apparatus 100 shown in FIG. 7, cartridges 103 which configure ink supply units are detachably provided on a recording head unit 102 having an ink jet recording head 101 that ejects ink. A carriage 104 that mounts the recording head unit 102 thereon is provided so as to be freely movable in an axial direction on a carriage shaft 106 attached to a recording apparatus body 105. The recording head unit 102 ejects, for example, a black ink composition and color ink compositions.

Drive force of a drive motor 107 is transmitted to the carriage 104 through a plurality of gears (not shown) and a timing belt 108, whereby the carriage 104 that mounts the recording head unit 102 thereon is moved along the carriage shaft 106. In the recording apparatus body 105, a platen 109 is provided along the carriage shaft 106. A recording sheet S that is an ejection target medium onto which the ink is to be ejected, such as paper fed by a sheet feeder 110, is wound around the platen 109 and is transported. On the platen 109, the recording sheet S is printed by the ink ejected from the ink jet recording head 101. The recording sheet S printed on the platen 109 is discharged by a sheet discharger 120 provided on a side of the platen 109, which is opposite to the sheet feeder 110.

As shown in FIG. 8, the sheet feeder 110 is configured with a sheet feed roller 111 and a follower roller 112. The rotation shaft 3 of the above-mentioned piezoelectric motor 1 is fixed to an end portion of the sheet feed roller 111, and the sheet feed roller 111 is rotationally driven by the drive of the piezoelectric actuator 10. A first gear 113 is provided on the sheet feed roller 111 coaxially therewith.

The sheet discharger 120 is configured with a sheet discharge roller 121 and a follower roller 122. A second gear 123 is provided on the sheet discharge roller 121 coaxially therewith. The first gear 113 of the sheet feed roller 111 meshes with the second gear 123 of the sheet discharge roller 121 through a third gear 130 that meshes with the first gear 113, a fourth gear 131 that meshes with the third gear 130, and a fifth gear 132 that meshes with the fourth gear 131, whereby drive force of the piezoelectric motor 1 that rotationally drives the sheet feed roller 111 is transmitted to the sheet discharge roller 121.

While the sheet feeder 110 and the sheet discharger 120 are rotationally driven by the piezoelectric motor 1 in the example shown in FIGS. 7 and 8, for example, the piezoelectric motor 1 of the above-mentioned embodiment is also usable instead of the drive motor 107 that moves the carriage 104. As a matter of course, the piezoelectric motor 1 is also usable, for example, for a pump that supplies the ink to the ink jet recording head 101, and the like. Moreover, though the piezoelectric motor 1 of the above-mentioned embodiment is used in this embodiment, a drive source according to an aspect of the invention is not particularly limited to the piezoelectric motor 1.

Note that the invention widely covers liquid ejecting apparatuses in general, and it is possible to mount the piezoelectric motor on liquid ejecting apparatuses other than the above- mentioned ink jet recording apparatus. As the other liquid ejecting apparatuses, for example, mentioned are: a colorant ejecting apparatus for use in manufacturing color filters of a liquid crystal display and the like; an electrode material ejecting apparatus for use in forming electrodes of an organic EL display, a field emission display (FED) and the like; a bioorganic compound ejecting apparatus for use in manufacturing biochips; and the like.

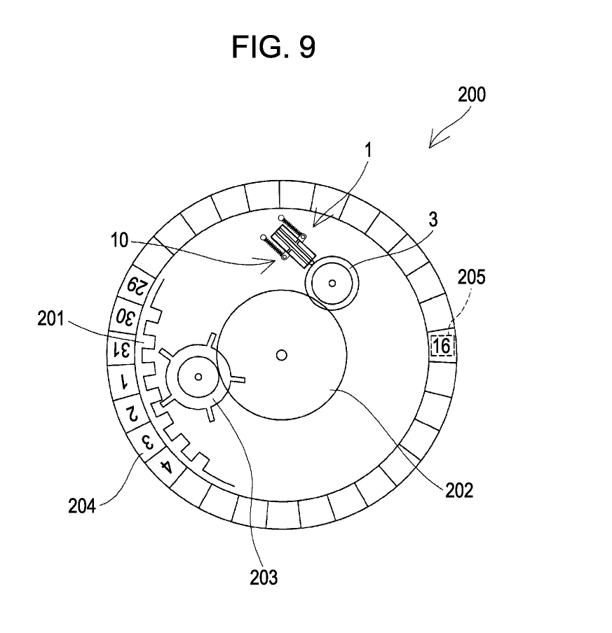

Moreover, the piezoelectric motor 1 of the above-mentioned embodiment is also usable as a drive unit of a timepiece. FIG. 9 illustrates an example of the timepiece that uses the piezoelectric motor 1 of the first embodiment.

As shown in FIG. 9, a calendar display mechanism that configures the timepiece 200 is coupled to the piezoelectric motor 1, and is driven by the drive force of the piezoelectric motor 1.

A principal portion of the calendar display mechanism includes: reduction train wheels that reduce a speed of the rotation of the rotation shaft 3 of the piezoelectric motor 1; and a ring-like date wheel 201. The reduction train wheels have a date indicator driving intermediate wheel 202 and a date indicator driving wheel 203.

When the rotation shaft 3 is rotationally driven clockwise by the piezoelectric actuator 10 of the above-mentioned piezoelectric motor 1, the rotation of the rotation shaft 3 is transmitted to the date indicator driving wheel 203 through the intermediate date wheel 202, and the date indicator driving wheel 203 rotates the date wheel 201 clockwise. All of the force transmission from the piezoelectric actuator 10 to the rotation shaft 3, the force transmission from the rotation shaft 3 to the reduction train wheels (intermediate date wheel 202, date indicator driving wheel 203), and the force transmission from the reduction train wheels to the date wheel 201 are performed in the in-plane direction. Therefore, the calendar display mechanism may be thinned.

A calender disc 204 on which numbers representing dates are printed along a circumferential direction is fixed to the date wheel 201. On a body of the timepiece 200, a window portion 205 that exposes therethrough one number among the numbers provided on the disc 204 is provided, whereby a date may be seen through the window portion 205. Although not illustrated, the timepiece 200 includes a minute hand, an hour hand, a movement that drives the minute hand and the hour hand, and the like.

Note that the piezoelectric motor 1 is usable not only for the calendar display mechanism but also for the movement that drives the minute hand, hour hand and the like of the timepiece. A structure to drive the minute hand, hour hand and the like of the timepiece is realizable only by incorporating the above-mentioned piezoelectric motor 1 instead of an electromagnetic motor and the like, which have been well known heretofore.

The invention widely covers piezoelectric motors in general, and is usable for small devices other than the above-mentioned liquid ejecting apparatus, timepiece and the like. As the small devices which may use the piezoelectric motor, there may be mentioned a medical pump, a camera, a robot such as an artificial arm, and the like.

What is claimed is:

1. A piezoelectric motor comprising:
a piezoelectric actuator including a piezoelectric element and a vibration member, the piezoelectric element having a piezoelectric layer and a first and a second electrodes provided above both surfaces of the piezoelectric layer, respectively, and the vibration member being fixed on the first electrode side of the piezoelectric element; and
a driven portion which is rotated by the protrusion portion of the vibration member vibrated by the piezoelectric element, while the driven portion being abutted thereon,
wherein a plurality of grooves which are open at a tip end surface of the protrusion portion and penetrate in a thickness direction are provided on a plurality of points of the protrusion portion along a rotation direction of a rotation shaft of the driven portion.

2. The piezoelectric motor according to claim 1,
wherein the grooves are formed so as to be deeper downstream with respect to the rotation direction of the rotation shaft.

3. The piezoelectric motor according to claim 1,
wherein the grooves are formed so as to be deeper as the grooves being nearer to the both side portions of the protrusion portion.

4. The piezoelectric motor according to claim 1,
wherein a plurality of grooves which are open at a contact surface of the driven portion with the protrusion portion and penetrate in the thickness direction are also provided on the driven portion along the rotation direction of the driven portion.

5. A liquid ejecting apparatus comprising the piezoelectric motor according to claim 1.

6. A timepiece comprising the piezoelectric motor according to claim 1.
